(19) United States
(12) Patent Application Publication
(10) Pub. No.: US 2013/0219306 A1
(43) Pub. Date: Aug. 22, 2013

(54) METHOD FOR REALIZING IC EQUIPMENT CONTROL SOFTWARE-ORIENTED GUI PLATFORMIZATION

(71) Applicants: Haibin Yu, Shenyang (CN); Aidong Xu, Shenyang (CN); Mingzhe Liu, Shenyang (CN); Zheng Li, Shenyang (CN); Kai Wang, Shenyang (CN); Ni Jin, Shenyang (CN); Jilong Zhang, Shenyang (CN)

(72) Inventors: Haibin Yu, Shenyang (CN); Aidong Xu, Shenyang (CN); Mingzhe Liu, Shenyang (CN); Zheng Li, Shenyang (CN); Kai Wang, Shenyang (CN); Ni Jin, Shenyang (CN); Jilong Zhang, Shenyang (CN)

(73) Assignee: Shenyang Institute of Automation of the Chinese Academy of Science

(21) Appl. No.: 13/879,248

(22) PCT Filed: Nov. 29, 2010
(86) PCT No.: PCT/CN2010/079216

§ 371 Date: Apr. 12, 2013

(30) Foreign Application Priority Data
Oct. 15, 2010 (CN) 201010508022.0

(51) Int. Cl. G06F 9/44

(52) U.S. Cl. CPC G06F 8/38
USPC 715/762

(57) ABSTRACT

The present invention relates to a method for realizing IC (integrate circuit) equipment control software-oriented GUI (graphical user interface) platformization, comprising the following steps: developing a corresponding IC equipment drive module in accordance with the characteristics of different manufacturers' IC equipment and drawing a GUI platform; connecting the monitoring host of the IC equipment to a controller through the IC equipment drive module, thereby forming a communication network; the IC equipment drive module reads data in the controller through the connection network and maps the data to the general data layer of the GUI platform; the GUI platform performs real-time display, control, and exception handling on the data through the general data layer, thus realizing GUI platformization of the IC equipment control software. The present invention realizes a cross-platform mechanism, improves the cluster monitoring ability of the wafer manufacturing equipment, is able to meet the user's demands for flexible configuration of the human-machine interface of the corresponding control system such that the whole production process can be quickly configured in a very short time, and meets the needs of advanced startup of the production.

### BACKGROUND OF THE INVENTION

1. Technical Field

The present invention belongs to the technical field of configuration monitoring and communication, and specifically relates to a method for realizing IC equipment control software-oriented GUI platformization.

2. Description of Related Art

At present, the investment of domestic semiconductor manufacturers in the technology of processing wafers by IC (integrate circuit) equipment has been directed to wafers with a diameter of 12 inches. The wafer production procedures are getting more and more complicated day by day, while many kinds of production equipment may be purchased from different equipment manufacturers, which brings difficulty to interaction and production management of senior human-machine GUIs (graphical user interfaces). Particularly, for the interaction of the human-machine GUI, a new application program is required to be developed in accordance with the different equipment manufacturers and users every time. This hinders the acceleration of product production and fails to meet the demands for quick operation of the production line in the semiconductor production process.

The software adopted by the domestic semiconductor equipment manufacturers is mainly directly purchased from overseas or simply a secondary development product of the purchased authorized software, which is highly limited in use and cannot be utilized in other manufacturer's equipment. The operation cost is extremely high.

At present, no universal product software is available on the domestic and overseas markets. Almost all equipment manufacturers face problems of innovation in the human-machine GUIs of the equipment and GUI development of new systems.

### BRIEF SUMMARY OF THE INVENTION

To solve the technical problem of overcoming the defects of the semiconductor equipment in the prior arts, such as the poor universality of the product software, the present invention provides a method for realizing IC equipment control software-oriented GUI platformization.

To solve the mentioned technical problem, the present invention adopts the following technical scheme:

A method for realizing IC equipment control software-oriented GUI platformization provided by the present invention comprises the following steps:

Developing a corresponding IC equipment drive module in accordance with the characteristics of different manufacturers' IC equipment and drawing a GUI platform;

Connecting the monitoring host of the IC equipment to a controller through the IC equipment drive module, thereby forming a communication network;

The IC equipment drive module reads data in the controller through the connection network and maps the data to the general data layer of the GUI platform;

The GUI platform performs real-time display, control, and exception handling on the data through the general data layer, thus realizing GUI platformization of the IC equipment control software.

The step of connecting the monitoring host of the IC equipment to a controller through the IC equipment drive module comprises the following steps:

Judging if the monitoring host of the IC equipment and the controller have established a connection or not;

If not, connecting the monitoring host of the IC equipment and the controller, meanwhile judging if the connection is overtime;

If not, which means the connection between the monitoring host and the controller is completed in a regulated time, starting a data receiving thread, registering a callback function, establishing a command output channel, and then the IC equipment drive module transmits an operation request command to the controller;

Judging if the IC equipment drive module's transmission of an operation request command to the controller is overtime;

If not, which means the transmission is successful, receiving a response data packet, and ending one operation request;

If transmitting the operation request command is overtime, feeding back the error code to the IC equipment drive software, and ending one operation request;

If the monitoring host and the controller have been connected or the connection is overtime, ending the connection between the monitoring host and the controller.

The step of registering the callback function comprises the following steps:

The IC equipment drive module receives the callback data;

Encoding the data according to the type of the callback data packet;

Issuing the encoded data packet as the data event to the GUI platform, and then ending the callback.

The step where the GUI platform performs data control with the general data layer comprises the following steps:

When there is an user control operation request, respectively sending it to the corresponding output channel according to the operation type; and,

Writing the user control operation request into the controller through the IC equipment drive module.

The step where the GUI platform performs real-time data display with the general data layer comprises the following steps:

Registering an event receiving callback interface;

Judging if it responds to the event; if responding to the event; decoding the received data packet to obtain the encoded data segment;

Issuing the data segment to an IC image element control according to the callback type;

Judging if the name of the data segment is identical with the user configuration name of the IC image element control interface or not;

If so, refreshing the value corresponding to the user configuration name of the IC image element control interface, and ending the real-time display;

If the name of the data segment is not identical with the user configuration name of the IC image element control interface, returning to the step of judging if the name of the data segment is identical with the user configuration name of the IC image element control interface or not; and,

If not responding to the event, returning to the step of judging if there is a response to the event.

The GUI platform is established by the following procedure:

Drawing a GUI platform of the IC equipment by means of the graphic software;

Configuring an IC image element control interface in the GUI platform;

Configuring the variable name of the IC equipment drive module in the IC image element control interface;

Storing the configuration item to end the establishment of the GUI platform.

The present invention has the following benefits and advantages:

1. The present invention adopts a standard distributed network interface protocol, providing a standard software interface and a Human-machine GUI realizing method for a cluster control system of the semiconductor equipment, and benefiting to standardization of different IC equipment control systems; the encapsulation of the bottom interface of the operation system realizes the cross-platform mechanism and improves the cluster monitoring ability of the wafer manufacturing equipment, and therefore effectively solves the problems of communication and control of human-machine interaction and improves the automation level of processing and equipment management of the semiconductor manufacturers.

2. By performing data collection, equipment control, and exception handling on the control equipment and encapsulation of the human-machine GUI image element mechanism, the present invention can meet users' demands for flexible configuration of the human-machine interface of the corresponding control system, so the whole production equipment can be quickly configured in a short time in the production process to meet the production need on advanced startup.

3. By the request response processing mechanisms of callback and event, the present invention perfects the communication between the GUI and the controller, effectively solves the problems of abnormality warning and real-time monitoring, and effectively meets the requirements of the production process.

### BRIEF DESCRIPTION OF THE SEVERAL VIEWS OF THE DRAWINGS

FIG. 1 shows a flow chart where the equipment drive module connects the controller.

FIG. 2 shows a flow chart of registering callback and transmitting a command.

FIG. 3 is a structural view of an IC image element control module.

FIG. 4 shows a refreshing flow chart of an IC image element control.

FIG. 5 is a structural view of a graphic configuration module of the GUI.

FIG. 6 is an EventArg message format self-defined by the user.

FIG. 7 is an interface view of an embodiment.

### DETAILED DESCRIPTION OF THE INVENTION

The invention is further described in detail with the reference to the attached drawings.

A method for realizing IC equipment control software-oriented GUI platformization provided by the present invention comprises the following steps:

1) Develop corresponding IC equipment drive module in accordance with the characteristics of different manufacturers' IC equipment.

In this embodiment, DeviceNet PLC is used as an example. This controller integrates all control data required by the IC equipment. In order to read and write the data of this controller to meet the production needs, the IC equipment drive module of the controller is developed according to the DeviceNet protocol. Firstly, establish a DeviceNet client object; secondly, construct a DeviceNet protocol request data packet and transmit a reading operation request command to the controller; thirdly, the controller feeds back response data according to the request; and fourthly, the IC equipment drive module resolves a response data packet according to the DeviceNet protocol to obtain the real-time data of the controller. When there is a writing operation request, transmit a writing operation command to the data variable to undergo writing operation according to the constructed DeviceNet client object, and then complete the writing operation request.

2) Draw a GUI platform.

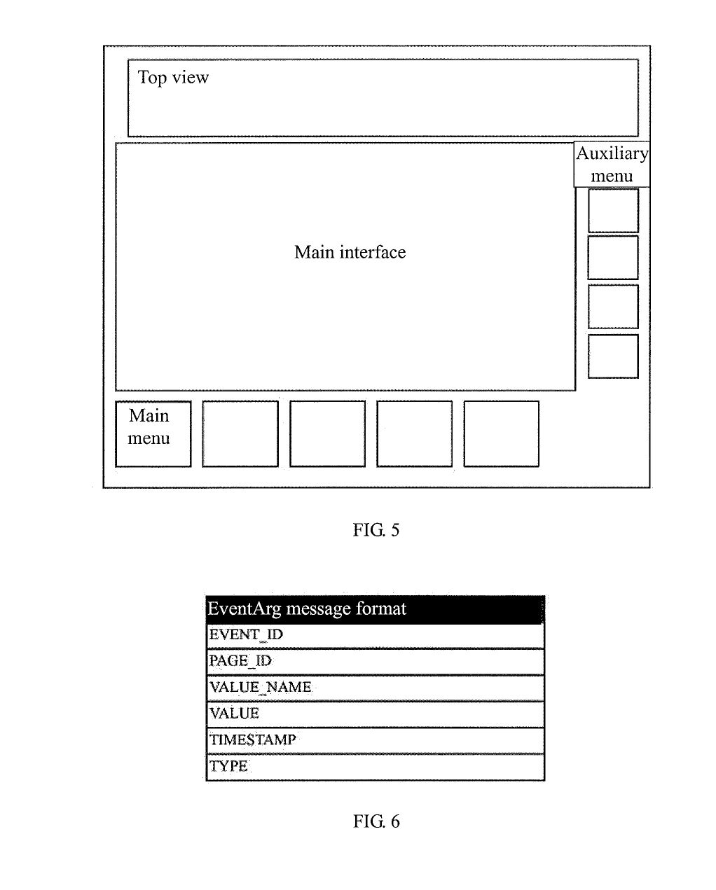

Draw a corresponding monitoring image picture by the IC image element control or the self-defined means of the user in accordance with different manufacturers' IC equipment characteristics. This process can be determined by the specific procedure of the user, but the development of the IC image element control must observe the regulations of the present invention. The drawn GUI platform must be manually configured prior to monitoring. Details refer to FIG. 5.

3) Connect the monitoring host of the IC equipment to a controller through the IC equipment drive module, thereby forming a communication network.

4) The IC equipment drive module reads data in the controller through the connection network and maps the data to the general data layer of the GUI platform.

After the connection between the IC drive module and the controller succeeds, the real-time data of the controller can be read at a fixed time, and the operation command can be issued in accordance with the user's operation request. The data can all be mapped to the general data layer of the GUI platform. The general data layer is a data buffer pool for buffering data and provides a data source for the real-time data display of the GUI platform.

5) The GUI platform performs real-time display, control, and exception handling on the data through the general data layer, thus realizing GUI platformization of the IC equipment control software.

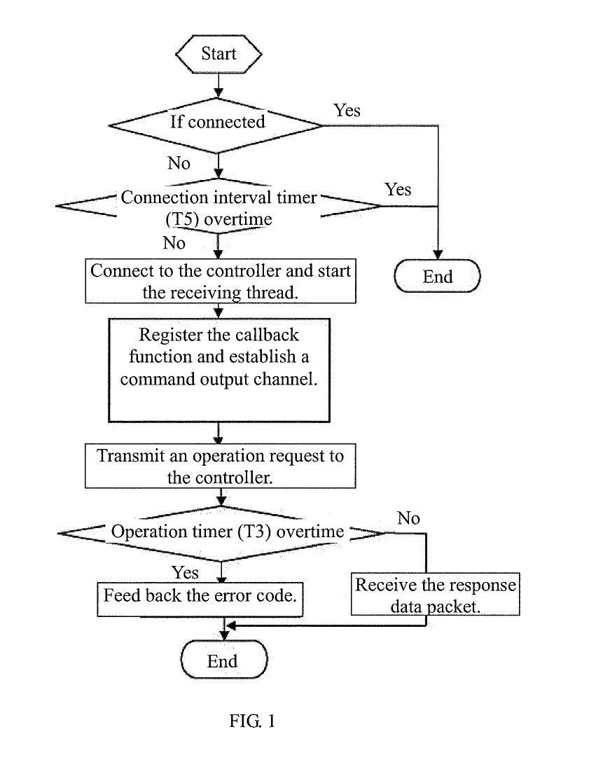

FIG. 1 shows a flow chart where the equipment drive module connects the controller. The step of connecting the monitoring host of the IC equipment to a controller through the IC equipment drive module comprises the following steps:

Judging if the monitoring host of the IC equipment and the controller have established a connection or not;

If not, connecting the monitoring host of the IC equipment and the controller, meanwhile judging if the connection is overtime (in this embodiment, the set time of the connection interval timer T5 is 5s);

If not, which means the connection between the monitoring host and the controller is completed in a regulated time, starting a data receiving thread, registering a callback function, establishing a command output channel, and then the IC equipment drive module sends an operation request command to the controller;

Judging if the IC equipment drive module's sending of an operation request command to the controller is overtime (in this embodiment, the set time of the selection timer T3 is 3s);

If not, which means the transmission is successful, receiving a response data packet, and ending one operation request;

If transmitting the operation request command is overtime, feeding back the error code to the IC equipment drive software, and ending one operation request;

If the monitoring host and the controller have been connected or the connection is overtime, ending the connection between the monitoring host and the controller.

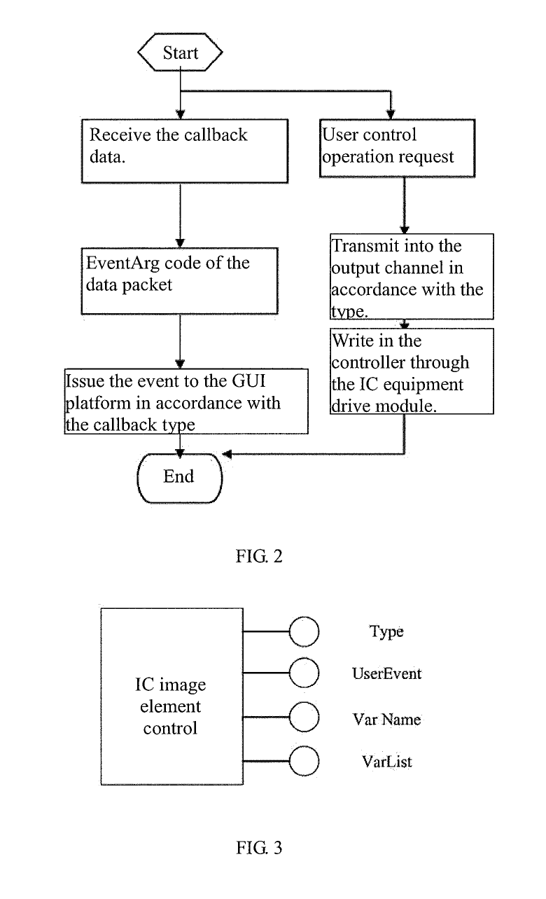

FIG. 2 shows a flow chart of registering callback and transmitting a command. The step of registering the callback function comprises the following steps:

The IC equipment drive module receives the callback data;

Encoding the data according to the type of the callback data; in this embodiment, encoding the callback data into to data in the EventArg message format;

Issuing the encoded data packet as the data event to the GUI platform, and then ending the callback. The encoded data is re-used to issue the senior IC image element control through events for refreshing the data.

The step where the GUI platform performs data control with the general data layer comprises the following steps:

When there is a user control operation request, respectively sending it to the corresponding output channel according to the operation type; and,

Writing the user control operation request into the controller through the IC equipment drive module.

FIG. 3 is a structural view of the IC image element control module: the IC image element control is self-developed by the user, meeting the regulated interface requirements. The type interface is used for presenting the type of the control; the user event interface UserEvent is used for presenting the user operation command of the user; the variable name interface VarName is used for saving a space for the user for self configuring the variable; and the variable list interface VarList is used for a consistent refreshing call interface for the main program.

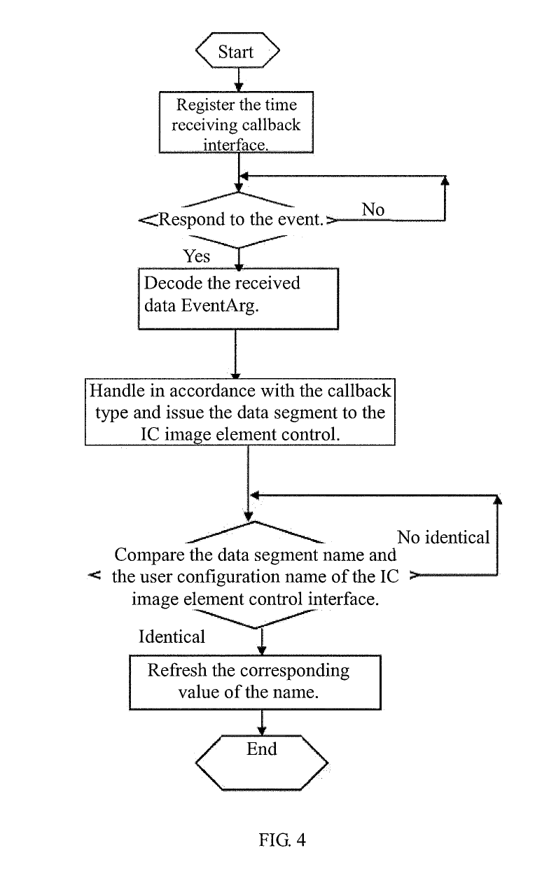

FIG. 4 shows a refreshing flow chart of an IC image element control. The step is where the GUI platform performs real-time data display with the general data layer comprises the following steps:

Registering an event receiving callback interface; when receiving the real-time data of the controller, the IC equipment drive module receives the call interface by the registered event to issue the real-time data event; only when the data changes, issuing the event;

Judging if it responds to the event; if responding to the event, decoding the received data packet to obtain the encoded data segment, wherein this embodiment adopts EventArg to resolve the data to obtain an EventArg message queue and then obtain a call type according to the message format;

Issuing the data segment to an IC image element control according to the callback type;

Judging if the name of the data segment is identical with the user configuration name of the IC image element control interface or not;

If so, refreshing the value corresponding to the user configuration name of the IC image element control interface, and ending the real-time display;

If the name of the data segment is not identical with the user configuration name of the IC image element control interface, returning to the step of judging if the name of the data segment is identical with the user configuration name of the IC image element control interface or not;

If not responding to the event, returning to the step of judging if responding to the event.

FIG. 5 is a structural view of a graphic configuration module of the GUI. The GUI platform is established by the following procedure:

Draw a GUI platform for the IC equipment by means of graphic software (including the platform self-drawn by the user and the IC image element control self-developed by the user).

In this embodiment, the Visual Studio .Net 2005 graphic editing software is used as an example to develop the IC image element control and draw the GUI platform to configure the variables. Firstly, establish a user control item so that the user can self-develop the image element interface according to the IC image element control interface; and secondly, drag the developed image element control to the GUI platform, and then the user himself/herself can determine the positions of this image element control in the views of the GUI platform and the relevant attribute configuration.

Configure an IC image element control interface in the GUI platform.

After placing the control and drawing of the GUI platform, the user is required to configure the variables of the image element interface. Click the IC image element control in the Visual Studio .Net 2005 GUI platform, and select the IC image element control interface in the attribute column to perform configuration.

Configure the variable name of the IC equipment drive module in the IC image element control interface.

After the user selects the IC image element control in the Visual Studio .Net 2005 GUI platform, the interface attribute will appear in the attribute column. The user can associate the variable name in the IC equipment drive module to the corresponding VarName interface at this position, thereby completing the match and association between the image element and the controller variable.

Store the configuration item to end the establishment of the GUI platform.

After completing the related configuration work, the user can store the item of the GUI platform as a monitoring embodiment. When compiling and running this embodiment, monitoring is carried out.

In this embodiment, the GUI platform is divided into a main menu, an auxiliary menu, a main view and a top view, wherein the top view shows the part shared by all GUIs; the main view shows the container of the GUI, capable of containing many GUIs with different functions; the main menu shows the navigation buttons of the main view interface; while the auxiliary menu shows the GUI's auxiliary navigation buttons associated with the navigation buttons. By this master-slave mode, switching among the GUI images is realized.

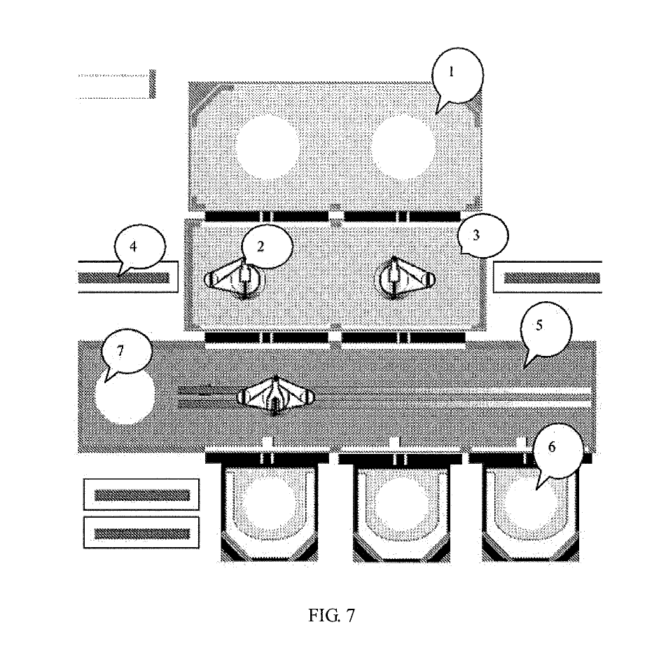

The interface image of the embodiment can be seen in FIG. 7, wherein 1 represents the IC image element control of a processing chamber; 2 represents the IC image element control of a vacuum mechanical arm; 3 represents the IC image element control of a vacuum transfer chamber; 4 represents the IC image element control in the lateral view of the mechanical arm; 5 represents the IC image element control of a transport chamber where a atmosphere mechanical arm is located; 6 represents the IC image element control of a wafer access slot; and 7 represents the IC image control of a wafer correction slot.

FIG. 6 is an EventArg message format self-defined by the user. A standard event type is adopted, wherein each event message comprises an event message head EVENT-ID including totally four bytes, a page identifier PAGE-ID including totally four bytes and a message body: VALUE-NAME, VALUE, TIEMSTAMP and TYPE all are character strings. The message body may be one variable or a combination of many variables.

For example, if define EventArg VarList[n], n=100, then the message is a combination of 100 variables, and each variable has a data segment described by the message format.

1. A method for realizing IC equipment control software-oriented GUI platformization, comprising the following steps:
developing a corresponding IC equipment drive module in accordance with the characteristics of different manufacturers' IC equipment and drawing a GUI platform;
connecting the monitoring host of the IC equipment to a controller through the IC equipment drive module, thereby forming a communication network;
the IC equipment drive module reads data in the controller through the connection network and maps the data to the general data layer of the GUI platform; and,
the GUI platform performs real-time display, control, and exception handling on the data through the general data layer, thus realizing GUI platformization of the IC equipment control software.

2. The method for realizing IC equipment control software-oriented GUI platformization according to claim 1, wherein the step of connecting the monitoring host of the IC equipment to a controller through the IC equipment drive module comprises the following steps:
judging if the monitoring host of the IC equipment and the controller have established connection or not;
if not, connecting the monitoring host of the IC equipment and the controller, meanwhile judging if the connection is overtime;
if not, which means the connection between the monitoring host and the controller is completed in a regulated time, starting a data receiving thread, registering a callback function, establishing a command output channel, and then the IC equipment drive module sends an operation request command to the controller;
judging if the IC equipment drive module's sending of an operation request command to the controller is overtime;
if not, which means the transmission is successful, receiving a response data packet, and ending one operation request.

3. The method for realizing IC equipment control software-oriented GUI platformization according to claim 2, wherein: if transmitting the operation request is overtime, feeding back the error code to the IC equipment drive software, and ending one operation request.

4. The method for realizing IC equipment control software-oriented GUI platformization according to claim 2, wherein: if the monitoring host and the controller have been connected or the connection is overtime, ending the connection between the monitoring host and the controller.

5. The method for realizing IC equipment control software-oriented GUI platformization according to claim 2, wherein: the step of registering the callback function comprises the following steps:
the IC equipment drive module receives the callback data;
encoding the data according to the type of the callback data;
issuing the encoded data packet as the data event to the GUI platform, and then ending the callback.

6. The method for realizing IC equipment control software-oriented GUI platformization according to claim 2, wherein: the step where the GUI platform performs data control with the general data layer comprises the following steps:
when there is an user control operation request, respectively sending it to the corresponding output channel according to the operation type; and,
writing the user control operation request into the controller through the IC equipment drive module.

7. The method for realizing IC equipment control software-oriented GUI platformization according to claim 1, wherein: the step where the GUI platform performs real-time data display with the general data layer comprises the following steps:
registering an event receiving callback interface;
judging if responding to the event; if responding to the event, decoding the received data packet to obtain the encoded data segment.
issuing the data segment to an IC image element control according to the callback type;
judging if the name of the data segment is identical with the user configuration name of the IC image element control interface or not;
if so, refreshing the value corresponding to the user configuration name of the IC image element control interface, and ending the real-time display.

8. The method for realizing IC equipment control software-oriented GUI platformization according to claim 7, wherein: if the name of the data segment is not identical with the user configuration name of the IC image element control interface, returning to the step of judging if the name of the data segment is identical with the user configuration name of the IC image element control interface.

9. The method for realizing IC equipment control software-oriented GUI platformization according to claim 7, wherein: if not responding to the event, returning to the step of judging if responding to the event.

10. The method for realizing IC equipment control software-oriented GUI platformization according to claim 1, wherein: the GUI platform is established by the following procedure:
drawing a GUI platform of the IC equipment by means of the graphic software;
configuring an IC image element control interface in the GUI platform;
configuring the variable name of the IC equipment drive module in the IC image element control interface; and,
storing the configuration item to end the establishment of the GUI platform.
